(19) United States
(12) Patent Application Publication
(10) Pub. No.: US 2015/0199782 A1
(43) Pub. Date: Jul. 16, 2015

(54) Population Health Risk Stratification Using Multi-Dimensional Model

(71) Applicant: PSC, INC., Allen, TX (US)

(72) Inventors: Jayaram Reddy, Allen, TX (US); Kirit Pandit, Plano, TX (US)

(73) Assignee: PSC, INC., Allen, TX (US)

(21) Appl. No.: 14/152,850

(22) Filed: Jan. 10, 2014

(51) Int. Cl. G06Q 50/22; G06Q 10/00

(52) U.S. Cl. CPC G06Q 50/22; G06Q 10/00

(57) ABSTRACT

Various disclosed embodiments include methods and systems for population health risk stratification. The population comprises a plurality of patients. The method includes determining clinical risk factors of the plurality of patients from the patients' clinical data. The method includes determining utilization risk factors of the plurality of patients. The method includes determining compliance risk factors of the plurality of patients, wherein the compliance risk factors are determined from appointment compliance factor, referral compliance factor and medication compliance factor. The method includes determining health risk scores of the plurality of patients from the clinical risk factors, the utilization risk factors and the compliance risk factors. The method includes classifying population health risks based on the health risk scores.

### TECHNICAL FIELD

The present disclosure is directed, in general, to data processing systems and methods and, more particularly, to methods and systems for population health health risk stratification using a multi-dimensional model.

### BACKGROUND OF THE DISCLOSURE

In the last several decades, healthcare spending in the U.S. has grown rapidly. According to a recent study, the per-capita healthcare spending in the U.S. increased from $1,110 in 1980 to $8,402 in 2010. Consequently, restraining the growth of healthcare spending is seen as an increased priority.

Various plans have been put forward to slow the growth of healthcare spending. Some plans support greater emphasis on prevention, wellness, and public health activities to reduce the overall healthcare cost. Other plans increase payments for primary care services and support a shift from “curing the sick patient” to “keeping the population healthy”, with a focus on preventive care provided by primary care physicians. Other plans propose a change from a volume-based payment to an outcome based pay-for-performance.

In order to restrain the growth of healthcare spending and to effectively manage healthcare costs, it is desirable to determine health risks associated with a patient population. It is desirable to stratify or classify the health risk of a population. Accordingly, methods and systems for stratification of health risks of a population are desired.

### SUMMARY OF THE DISCLOSURE

Various disclosed embodiments include methods and systems for population health risk stratification. The population comprises a plurality of patients.

The method includes determining clinical risk factors of the plurality of patients from the patients' clinical data. The method includes determining utilization risk factors of the plurality of patients from per-member healthcare costs over a predetermined time period. The method includes determining compliance risk factors of the plurality of patients, wherein the compliance risk factors are determined from care guideline compliance factor appointment compliance factor, referral compliance factor and medication compliance factor. The method includes determining health risk scores of the plurality of patients from the clinical risk factors, the utilization risk factors and the compliance risk factors. The method includes classifying population health risks based on the health risk scores. The method includes storing the health risk scores and the resulting classifications in a memory. The health risk scores indicate risk of hospitalization or other high-cost interventions.

According to various disclosed embodiments, the health risk score is represented by the following relationship: Health Risk Score=[X1*Clinical Risk Factor+X2*Utilization Risk Factor+X3*Compliance Risk Factor], wherein X1, X2 and X3 are coefficients. According to various disclosed embodiments, the per-member healthcare cost over a predetermined time period is per-member per-month (PMPM) cost. According to various disclosed embodiments, the utilization risk factor is represented by the following relationship: Utilization Risk Factor=[(Upper Limit−PMPM)/(Upper Limit−Lower Limit)]*100. According to various disclosed embodiments, the compliance risk factor is represented by the following relationship: Compliance Risk Factor=(Appointment Compliance Score+Referral Compliance Score+Medications Compliance Score+Care Guidelines Compliance score)/4.

According to various disclosed embodiments, the referral compliance score is determined from referral visits and number of referrals. According to various disclosed embodiments, the referral compliance score is represented by the following relationship: Referral Compliance Score=[(number of referral visits)/(number of referrals)]*100.

According to various disclosed embodiments, the method includes identifying disease models in clinical codes and mapping disease codes to respective chronic diseases. The method includes determining, for the plurality of patients, health risk scores for the respective chronic diseases by applying disease models for the respective chronic diseases to the clinical data. The method includes determining, for the plurality of patients, average health risk scores of the respective chronic diseases; and determining, for the plurality of patients, weighted health risk scores of the respective chronic diseases, wherein the weighted health risk score is determined from the average health risk score of the chronic disease and the average cost of hospitalization due to the chronic diseases. The method includes storing weighted health risk scores and other results in a memory.

According to various disclosed embodiments, a data processing system for population health risk stratification includes at least one processor and a memory connected to the processor. The data processing system is configured to determine clinical risk factors of the plurality of patients from the patients' clinical data. The data processing system is configured to determine utilization risk factors of the plurality of patients from per-member healthcare costs over a predetermined time period. The data processing system is configured to determine compliance risk factors of the plurality of patients. The compliance risk factors are determined from appointment compliance factor, referral compliance factor and medication compliance factor. The data processing system is configured to determine health risk scores of the plurality of patients from the clinical risk factors, the utilization risk factors and the compliance risk factors. The data processing system is configured to classify population health risks based on the health risk scores. The health risk scores and other results are stored in a memory.

According to various disclosed embodiments, the health risk score is represented by the following relationship: Health Risk Score=[X1*Clinical Risk Factor+X2*Utilization Risk Factor+X3*Compliance Risk Factor], wherein X1, X2 and X3 are or coefficients. According to various disclosed embodiments, the per-member healthcare cost over a predetermined time period is per-member per-month (PMPM) cost. According to various disclosed embodiments, the utilization risk factor is represented by the following relationship: Utilization Risk Factor=[(Upper Limit−PMPM)/(Upper Limit−Lower Limit)]*100. According to various disclosed embodiments, the compliance risk factor is represented by the following relationship: Compliance Risk Factor=(Appointment Compliance Score+Referral Compliance Score+Medications Compliance Score+Care Guidelines Compliance Score)/4. According to various disclosed embodiments, the referral compliance score is determined from referral visits and number of referrals. According to various disclosed embodiments, the referral compliance score is represented by the following relationship: referral compliance score as [(number of referral visits)/(number of referrals)]*100.

According to various disclosed embodiments, the data processing system is configured to identify disease codes in clinical data and map disease codes in the clinical data to respective chronic diseases. The data processing system is configured to determine, for the plurality of patients, health risk scores for the respective chronic diseases by applying disease models for the respective chronic diseases to the clinical data. The data processing system is configured to determine, for the plurality of patients, average health risk scores of the respective chronic diseases. The data processing system is configured to determine, for the plurality of patients, weighted health risk scores of the respective chronic diseases, wherein the weighted health risk score is determined from the average health risk score of the chronic disease and the average cost of hospitalization due to the chronic diseases. The data processing system is configured to store the weighted health risk scores and other results in a memory.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system according to various disclosed embodiments;

FIG. 2 illustrates an exemplary block diagram for calculation of clinical risk scores according to various disclosed embodiments.

FIGS. 3 and 4 illustrate disease models;

FIG. 5 is a flowchart of a process according to various disclosed embodiments;

FIG. 6 is a flowchart of a process according to various disclosed embodiments.

### DETAILED DESCRIPTION

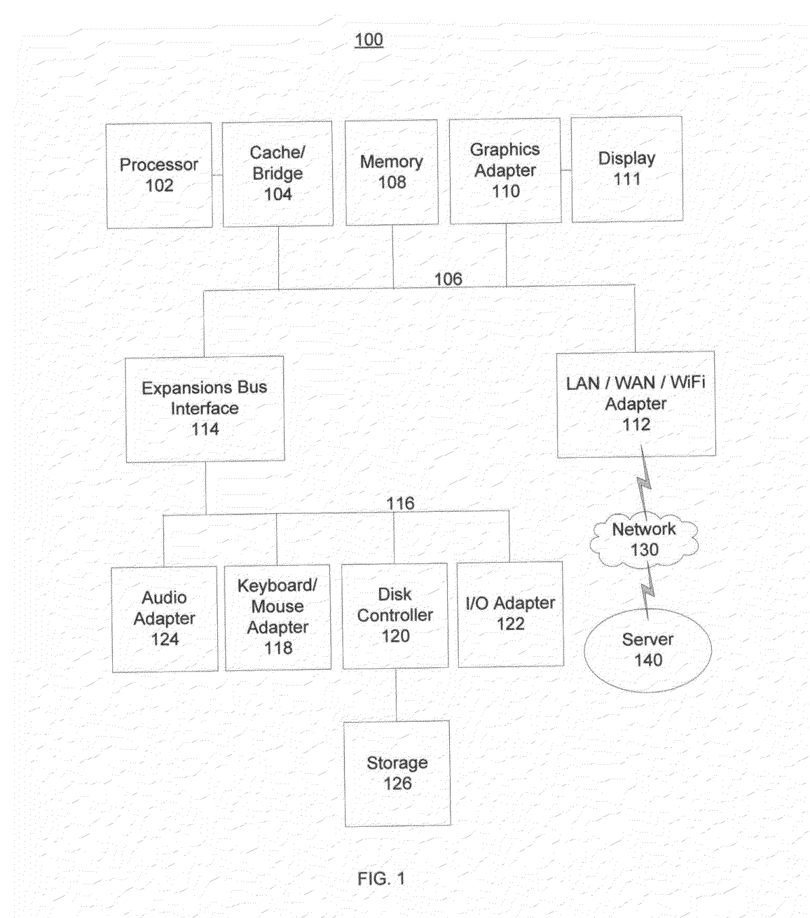

FIGS. 1 through 6, discussed below, and the various embodiments used to describe the principles of the present disclosure in this disclosure are by way of illustration only and should not be construed in any way to limit the scope of the disclosure. Those skilled in the art will recognize that the principles of the disclosure may be implemented in any suitably arranged device or a system. The numerous innovative teachings of the present disclosure will be described with reference to exemplary non-limiting embodiments

Various disclosed embodiments provide methods and systems for a population's health risk stratification based on a multi-dimensional model. By stratifying (i.e., classifying) a population's health risk, healthcare costs associated with the population may be predicted or forecast. The population comprises a plurality of patients who are also referred to as “members”.

According to various disclosed embodiments, a population's health risk is stratified or classified by determining the population's health risk score. The population's health risk score may be related to risk of hospitalization or other high cost intervention. Since hospitalization is related to healthcare cost, a population's health risk generally indicates probability or risk of future healthcare cost.

According to various disclosed embodiments, a population's health risk score may be determined by a state of health (SOH) analyzer. In this document, the health risk score is also referred to as the SOH score, and these terms are used interchangeably hereinafter. The health risk score or SOH score may be represented by a number between 1 and 100. Alternatively, the health risk score or SOH score may be represented as a percentage (e.g., 70%, 80%).

Healthcare Providers

Healthcare providers may use the health risk score to identify high-risk patients by chronic conditions based on clinical data. Also, healthcare providers may stratify or classify patients into risk pools and may develop optimal care-management programs. Also, healthcare providers may measure the performance of various care management programs.

Self-Insured Employers

Self-insured employers may utilize the various disclosed embodiments to gain increased visibility to the performance of providers and care management programs. Also, self-insured employers may measure the performance and return of investment (ROI) of wellness, case management, disease management and benefit programs.

Care Coordinators

Care coordinators may utilize the various disclosed embodiments to identify successful care management and well-being programs and the return of investment (ROI). Also, care coordinators may identify providers that are successful in providing Quality-of-Care at optimal costs.

According to various disclosed embodiments, a population's health risk score is determined using a multi-dimensional model. The multi-dimensional model may include clinical risk factor, utilization risk factor and compliance risk factor. The multi-dimensional model may include additional factors.

According to various disclosed embodiments, the clinical risk factor includes a risk of hospitalization due to chronic diseases. Such chronic diseases may include, for example, diabetes, congestive heart failure, coronary heart disease, asthma, COPD, and osteoporosis. The SOH analyzer may be used to determine the clinical risk factor based on information from a patient's health record such as, for example, clinical data. The clinical data may be obtained during a patent's visit to a healthcare provider and may also be obtained from a patient's hospitalization records. According to some disclosed embodiments, the clinical data may be obtained from an Electronic Medical Records (EMR) system.

FIG. 1 depicts a block diagram of data processing system 100 in which an embodiment can be implemented, for example, as a system particularly configured by software, hardware or firmware to perform the processes as described herein, and in particular as each one of a plurality of interconnected and communicating systems as described herein. Data processing system 100 may be implemented as an SOH analyzer according to various disclosed embodiments. The data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a server, PC, laptop, workstation or any other computing device, and a plurality of such computing devices may be linked via a communication network to form a distributed system in accordance with embodiments of the disclosure.

Clinical Risk Factor

According to various disclosed embodiments, clinical risk factors (also referred to as clinical risk scores) are calculated using a population's clinical data. The population comprises a plurality of patients. The clinical data may be obtained from electronic medical records or may otherwise be obtained manually. It will be appreciated that the clinical data may be gathered from a plurality of encounters over a period of time. An encounter may, for example, be a patient visit to a healthcare provider or a hospitalization due to a chronic condition.

According to various disclosed embodiments, the following information may be obtained: Patient: date of birth, gender, race.

By way of example, for encounters (visits) by a patient, the following information may be obtained:

Vitals (e.g., age, height, weight (BMI), temperature, heart rate, blood pressure)

Labs ordered

Lab results (e.g., blood sugar, HbA1c, LDL-C, HDL-C, triglycerides)

Medications prescribed

Diagnosis codes (e.g., ICD codes)

Procedure codes (ICD, CPT codes)

Charges

Claims

Payments

Hospital admission dates, charges, diagnosis codes

Pharmacy (medications ordered)

According to various disclosed embodiments, the clinical data is analyzed by system 100. System 100 may be implemented as an SOH analyser. System 100 identifies one of more chronic diseases the patient may have been diagnosed with. For example, ICD 9 codes entered in an encounter may indicate the chronic diseases. It will be appreciated that ICD (international classification of diseases) is a classification system for assigning specific diseases or conditions to a patient. For example ICD 9=250.xx covers various types of diabetes. Thus, ICD 9=250.3 indicates that a patient has been diagnosed with a particular type of diabetes.

According to various disclosed embodiments, ICD 9 codes for an encounter are mapped to corresponding chronic diseases. A database mapping ICD 9 codes to chronic diseases may be created.

According to various disclosed embodiments, the clinical data is analyzed by system 100 and the chronic diseases may be identified from the clinical data without rely on ICD 9 codes. For example, the clinical data may not include ICD 9 codes but may indicate the chronic diseases based on other information. Accordingly, system 100 may analyze the clinical data and identify the chronic diseases without requiring ICD 9 codes.

According to various disclosed embodiments, if the clinical data for an encounter does not have a recorded ICD 9 code that maps to a chronic condition but a previous encounter provided a recorded ICD 9 code, then the previously recorded ICD 9 code is propagated forward, unless the patient has a ‘resolved’ status for that chronic condition. A resolved status may indicate that the patient's chronic condition has been cured.

According to various disclosed embodiments, predetermined disease models are applied to the clinical data related to calculate a clinical risk factor. The clinical risk score is calculated for the chronic diseases for the patient encounters. By way of example, an encounter may indicate that a particular patient has been diagnosed with diabetes and CHD. Accordingly, predetermined disease models for both diabetes and CHD are applied to the respective clinical data obtained during the encounter to calculate the clinical risk score for diabetes and CHD. According to various disclosed embodiments, the clinical risk score may be represented by a number between 0 and 100 or may be represented by as a percentage (%). A high clinical risk score related to a chronic disease may indicate relatively poor health of a patient, and thus a relatively high risk of hospitalization due to the chronic disease. A low clinical risk score may indicate relatively good health of a patent and thus a relatively low risk of hospitalization due to the chronic disease.

According to various disclosed embodiments, the disease models are clinically validated models developed using multi-year trials on large patient populations. The disease models utilize regression equations to determine the relationship between causal factors (independent variables) and outcomes. The regression equations predict the probability of an outcome based on the clinical data. The regression equations are well known to those skilled in the art and thus will not be described herein.

According to various disclosed embodiments, the clinical risk factor is calculated for diabetes, asthma, COPD and depression only if a patient is diagnosed with those chronic diseases. For example, if a patient is diagnosed with diabetes, the clinical risk score is calculated according to the corresponding disease model for diabetes. For patients that are not diagnosed with diabetes, a zero is assigned for diabetes.

According to various disclosed embodiments, the clinical risk factor is calculated for pre-diabetes, hypertension, CAD, CHF and AVD.

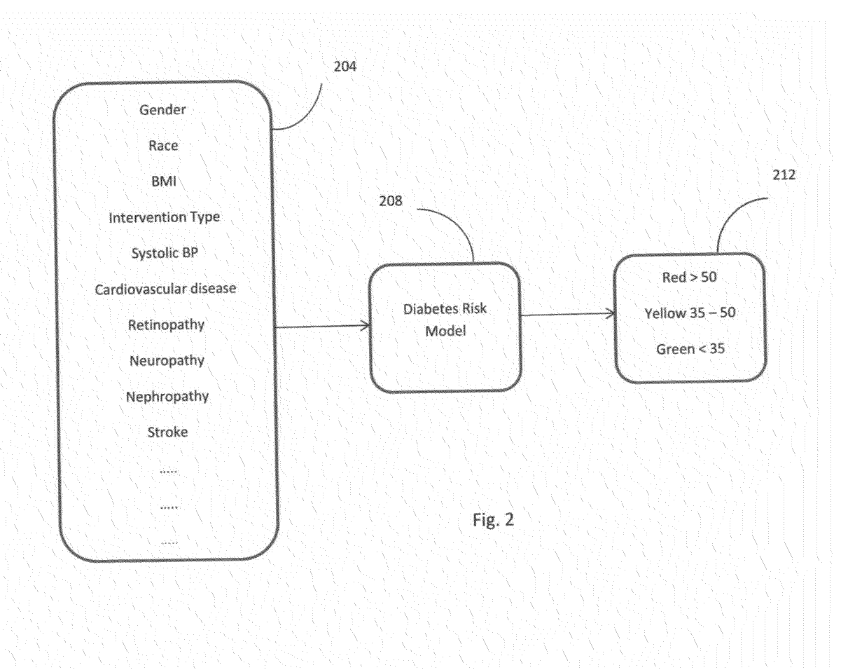

FIG. 2 illustrates an exemplary block diagram for calculation of the clinical risk score for diabetes according to various disclosed embodiments. Clinical data 204 is applied to diabetes model 208 to generate clinical risk factors or scores 212. As discussed before, diabetes model 208 may be implemented using regression equations.

According to various disclosed embodiments, the clinical risk factor for a patient diagnosed with diabetes may be calculated using guidelines provided in Table 1 below. The guidelines of Table 1 are an exemplary disease model for diabetes. The disease model may be modified or other disease models may be used to determine the clinical risk factor. Initially, for both male and female patients with type 2 diabetes, a baseline number of 0.31 is assigned. If the patient is a white female, 0.038 is added to the score. If the female patient has a BMI of 35, 0.021*5=0.105 is added to the score. If the female patent is on insulin, 0.034 is added to the score. If the female patient has regular neuropathy, 0.065 is added to the score. If the female patient is diagnosed with congestive heart failure, 0.052 is added to the score. Finally, if the female patient is diagnosed with hypertension, 0.011 is added to the score. Based on the disease model of Table 1, the clinical risk score for the female patient diagnosed with diabetes is 0.615 or 61.5%. As discussed before, the disease model of Table 1 may be modified, or other disease models may be used.

TABLE 1

| | | |
|---|---|---|
| Baseline: | Healthy diet-controlled Diabetic 2 | 0.31 |
| | white male with no complications or | |
| | comorbidities | |
| Sex | Male | 0 |
| | Female | 0.038 |
| BMI (kg/m2) For every | Obese | 0.021 |
| unit above 30 (kg/m2) | | |
| Diabeteic Intervention | Diet Controlled | 0 |
| | Oral Antidiabetic Agents | 0.023 |
| | Insulin | 0.034 |
| Retinopathy | Blind in one-eye | 0.043 |
| | Blind in two-eyes | 0.17 |
| Nephropathy | Microalbuminuria | 0.011 |
| | Proteinuria | 0.011 |
| | ESRD with dialysis | 0.078 |
| Neuropathy | Tingling and burning | 0.06 |
| | Neuropathy | 0.065 |
| | Sores | 0.099 |
| | History of amputation | 0.105 |
| Stroke | Transient ischemic attack or stroke | 0.044 |
| | Stroke with residual | 0.072 |
| Cardiovascular disease | Congestive heart failure | 0.052 |
| Blood Pressure | High blood pressure | 0.011 |

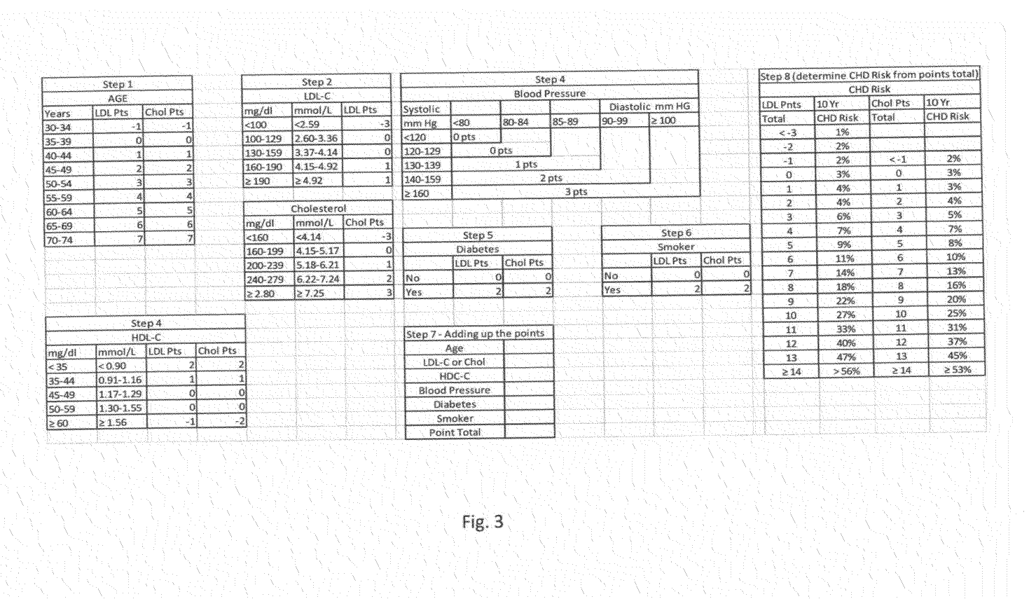

According to various disclosed embodiments, the clinical risk factor for a patient diagnosed with coronary heart disease (CHD) may be calculated using guidelines (i.e., disease model) in charts shown in FIG. 3, which shows various steps used in calculating the clinical risk score. Consider, for example, a 52 year old non-smoking male with the following conditions: LDL=192; HDL=46; systolic BP=130; and diastolic BP=90. Using the steps in FIG. 3, the clinical risk score is calculated to be 9, which corresponds to 22%. The disease model of FIG. 3 may be modified, or other disease models may be used to calculate the clinical risk factor.

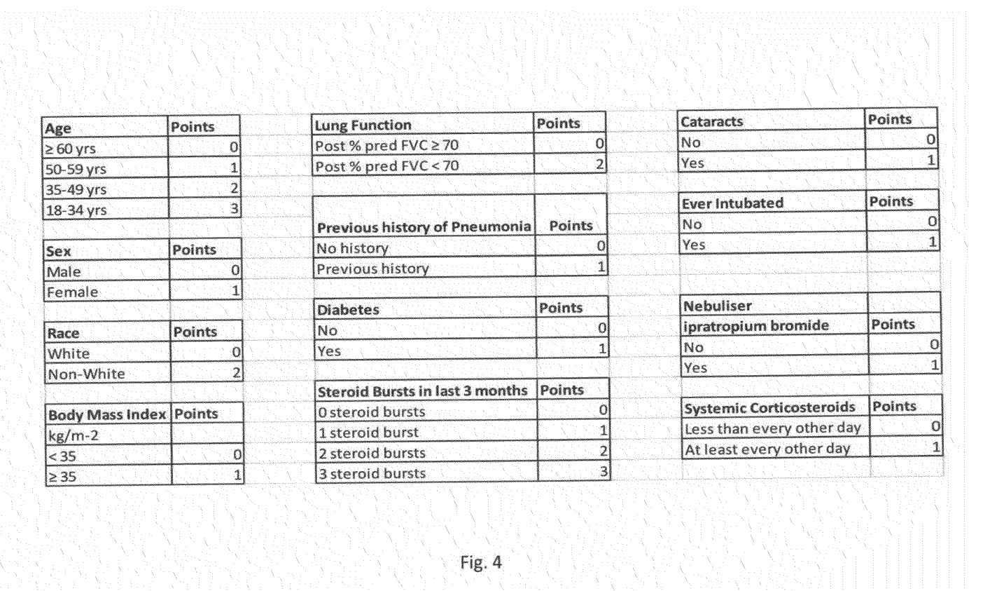

According to various disclosed embodiments, the clinical risk factor for a patient diagnosed with asthma may be calculated using guidelines (i.e., disease models) in charts shown in FIG. 4. In FIG. 4, each parameter is listed along with points to be added to the score. For example, if total points for a patient equal 18, the clinical risk score is 50%.

According to some disclosed embodiments, if an encounter does not have recorded values for any vital signs, the previously recorded values for vital signs are propagated forward. Consider, for example, in an encounter (visit) on Jan. 6, 2012 a patient had a recorded LDL cholesterol value of 150. In his next encounter (visit) on Jun. 4, 2012, no LDL value was recorded. Accordingly, the LDL value of 150 may be used for Jun. 4, 2012 encounter.

According to some disclosed embodiments, if a parameter value for any vital sign is not available across any encounter, reasonable approximations may be used depending on the parameter. For example, if a Body Mass Index (BMI) value is not available, an ideal BMI of 22.5 may be used.

According to some disclosed embodiments, the calculated clinical risk factors are normalized using a scale between 1 and 100. Next, an average health risk score over a predetermined time period for each patient for each chronic disease is calculated. For example, the average health risk score of a patient during a 12-month period may be calculated. If the patient's last encounter (visit) was on Jul. 6, 2012, then encounters between Jul. 7, 2011 and Jul. 6, 2011 may be considered. Consider, for example, a patient had one encounter in each quarter during a 12 month time period and the clinical risk factors for diabetes were as follows:

Quarter 4, 2011: 50

Quarter 1, 2012: 60

Quarter 2, 2012: 50

Quarter 3, 2012: 60

Based on the above, the average clinical risk factor is 55.

According to some embodiments, a weighted composite clinical risk factor for a chronic disease may be calculated using the average annual cost to treat a patient diagnosed with the chronic disease as a weight score. For example, if the average annual cost of treatment of a diabetes patient is twice that of an osteoporosis patient, the weight score for diabetes is twice the weight score for osteoporosis. Thus, the weighted composite health risk score indicates which patients are likely to be more costly. Table 2 below shows an example of the cost burdens (weights) that can be used for the chronic conditions listed in Table 2.

TABLE 2

| Chronic | Average Hospital Bill | Relative Cost |
|---|---|---|
| Condition | per Admission (US$) | Burden |
| CAD | 51,755 | 3.3 |
| CHF | 34,270 | 2.2 |
| Diabetes | 27,930 | 1.8 |
| Asthma | 15,660 | 1.0 |

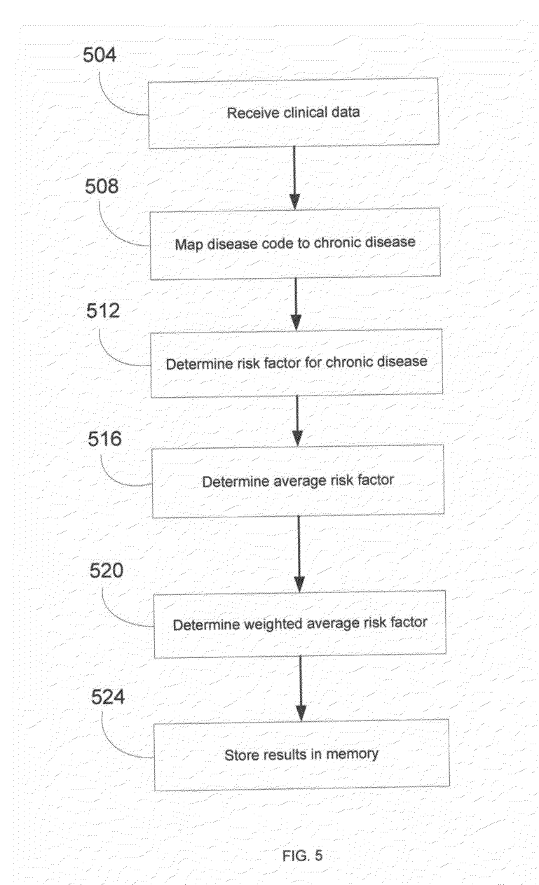

FIG. 5 is a flowchart of a process according to some disclosed embodiments. Such a process can be performed, for example, by system 100, which may be implemented as an SOH analyzer, as described above, but the “system” in the process below can be any apparatus configured to perform a process as described.

In block 504, system 100 receives a patient's clinical data. As discussed before, the clinical data may be collected from a plurality of encounters over a predetermined time period.

In block 508, system 100 maps disease codes in the clinical data to respective chronic diseases. As discussed before, according to some disclosed embodiments, system 100 may determine the chronic diseases from the clinical data without relying on any disease codes. Thus, some instances the clinical data may not include the disease codes, but system 100 may determine the chronic diseases from the clinical data.

In block 512, system 100 determines clinical risk factors (i.e., clinical risk scores) for the respective chronic diseases. As discussed before, the clinical risk scores are calculated by applying disease models for the respective chronic diseases to the clinical information.

In block 516, system 100 determines average clinical risk factors (i.e., clinical risk scores) of the respective chronic diseases from the plurality of encounters over the predetermined time period. In block 520, system determines weighted clinical risk scores of the respective chronic diseases. The weighted clinical risk score is determined from the average clinical risk score of the chronic disease and the average cost of hospitalization due to the chronic disease. In block 524, system 100 stores the results in a memory.

Utilization Risk Factor

According to various disclosed embodiments, system 100 calculates total cost incurred for a patent for encounters over a predetermined time period. For example, system 100 may calculate total cost incurred for a patient for encounters over a predetermined time period (e.g., last 2 years). Encounters may, for example, include primary care visits, outpatient visits, inpatient visits, post-discharge, and rehabilitation. According to disclosed embodiments, cost incurred may include money paid to providers by a payer, where providers may be physicians, hospitals or clinics.

According to various disclosed embodiments, system 100 calculates per member per month (PMPM) cost using previously calculated data. The PMPM cost may be calculated over a predetermined time period (e.g., 12 months, 24 months, 36 months). For example, if the total cost for a patient over the last 2 years is $100,000, then the PMPM cost is 100,000/24=$4166.66.

According to various disclosed embodiments, a histogram of the PMPM of the patients may be generated. System 100 may calculate average and standard deviation (SD) of PMPM.

According to various disclosed embodiments, system 100 calculates the utilization risk factor (also referred to as utilization risk score) from the PMPM values. The utilization risk score may, for example, be calculated as set forth below.

Lower and upper limits of PMPM may be set at (Average+5*Standard Deviation). Lower limit may be capped at zero. For example, if the Standard Deviation is $2000, and average is $500, then the lower limit may be set at 0 and the upper limit may be set at $10,500.

It will be apparent that other cost metrics that measure per member healthcare cost over a predetermined time period may be used instead of PMPM to calculate the utilization risk factors. For example, per-member-per-year costs may be used to calculate the utilization risk factors.

According to various disclosed embodiments, the PMPM values may, for example, be normalized on a scale of 0-100. By way of example, in the foregoing steps, PMPMs greater than $10,500 may be mapped to 100, and PMPMs of 0 may be mapped to 0. Accordingly, PMPM values between 0 and $10,500 may be mapped to a scale of 0-100 and the utilization risk score may be calculated as set forth below.

Utilization Risk Factor=[(Upper limit−PMPM)/(Upper limit−lower limit)]*100

Compliance Risk Factor

According to various disclosed embodiments, system 100 calculates compliance risk factor (also referred to as compliance risk score). The compliance risk factor may, for example, be calculated as a sum of referral compliance score, appointment compliance score and medication compliance score.

Referral Compliance Score or Factor

According to various disclosed embodiments, using referral data, referral compliance score or factor may be calculated as set forth below.

For patients, system 100 determines the number of referrals made to specialists over a predetermined time period (e.g., 12 months, 24 months, 36 months). Consider, for example, the referral records indicates the following:

January—Cardiologist Dr Johnson

February—Cardiologist Dr Johnson

June—Pain Specialist Dr McKnight

October—Psychiatrist Dr. Smith

Although the above records show 4 referrals, there were 3 actual referrals because there were two referrals to the same cardiologist.

System 100 then determines the number of referral visits. Consider, for example, the patient has encounters with Dr. Johnson and Dr. McKnight. Thus, the patient's referrals visits are 2.

According to various disclosed embodiments, system 100 calculates referral compliance score or factor as [(number of referral visits)/(number of referrals)]*100.

Thus, using the foregoing example, the compliance score is (2/3)*100=66.66%

Appointment Compliance Score or Factor

According to various disclosed embodiments, system 100 calculates appointment compliance score or factor. For example, appointment compliance score may be calculated using practice management data as set forth below.

For patients, number of appointments scheduled over a predetermined time period (e.g., 12 months, 24 months, 36 months) is determined. According to some disclosed embodiments, any appointments rescheduled within 3 weeks of the original appointment may not be considered. The number of appointments that were kept is determined.

According to some disclosed embodiments, system 100 calculates the appointment compliance score as set forth below.

Appointment Compliance Factor=[(number of appointments kept/number of appointments made)*100].

For example, if the number of appointments made is 10 but the number of appointments kept is 5, then the appointment compliance is 50%.

Medication Compliance Score or Factor

According to various disclosed embodiments, system 100 calculates medication compliance score or factor by analyzing medication data such as, for example, pharmacy claims data.

According to various disclosed embodiments, for a member (i.e., patient), drugs listed under a therapeutic family are considered. By way of example, a therapeutic family may be insulin, and under the therapeutic family insulin, one or more drugs such as, for example, Humalog, Novalog, Epidra may be listed. According to some disclosed embodiments, system 100 determines compliance as set forth below.

[SUM(days filled)/time period in months]*100

Consider, for example, that medication data for a patient in 2012 indicates the following:

Humalog days filled=180. Then Humalog compliance=50%.

Lantis days filled=90. Then Lantis compliance=25%.

Accordingly, based on the foregoing, total insulin compliance=37.5%.

According to various disclosed embodiments, system 100 determines the average compliance for the therapeutic classes for chronic conditions of the patient. Consider, for example, that the patient is diagnosed with the following chronic conditions: CAD and diabetes, and that the patient's compliance for the therapeutic families are as follows:

Statins=80%

Insulin=50%

According to some disclosed embodiments, system 100 determines the patient's overall medications compliance score or factor. The overall medications compliance score may be calculated by averaging the compliance of the therapeutic families score. Accordingly, using the foregoing data, the overall medications compliance score is (80%+50%)/2=65%

According to some disclosed embodiments, system 100 determines the compliance risk factor. The compliance risk factor may, for example, be determined by averaging appointment, referral and medication compliance scores. Alternatively, the compliance risk factor may be determined based on weighted average of appointment, referral and medications compliance scores.

Compliance Risk Factor=(appointment compliance factor+referral compliance factor+medications compliance factor)/3

Alternatively, the compliance risk score may be determined as follows:

Compliance risk factor=(X1*appointment compliance factor+X2*referral compliance factor+X3*medications compliance factor)/3, wherein X1, X2 and X3 are weight coefficients for appointment compliance factor, referral compliance factor and medications compliance factor, respectively.

According to various disclosed embodiments, system 100 determines the health risk score. The health risk score may be determined from the clinical risk factor, utilization risk factor and compliance risk factor. According to some disclosed embodiments, system 100 determines the health risk score as set forth below.

Health Risk Score=[X1*Clinical Risk Factor+X2*Utilization Risk Factor+X3*Compliance Risk Factor], wherein X1, X2 and X3 are weights or coefficients.

According to some disclosed embodiments, the following weights or coefficients are assigned:

Clinical Risk Factor—61.5%

Utilization Risk Factor—23.1%

Compliance Risk Factor—15.4%

Thus, the health risk score may be calculated as follows:

Health Risk Score=61.5*Clinical Risk Factor+23.1*Utilization Risk Factor+15.4*Compliance Risk Factor

Consider, for example, that the clinical risk factor=40, the utilization risk factor=70, and the compliance risk factor=60. Accordingly, the health risk score=(0.615*40+0.231*70+0.154*60)=50.01%.

According to some disclosed embodiments, additional factors may be utilized to determine the health risk score. For example, socio-economic factors, access to care factors, and well being factors in addition to the clinical risk factor, utilization factor, and compliance factor may be considered, and each of these factors may be assigned a respective weight or coefficient.

According to various disclosed embodiments, the health risk score may be classified into high risk, moderate risk and low risk categories. The health risk score may also be color coded as high risk, moderate risk and low risk.

According to various disclosed embodiments, patients with high PMPM are identified. Next, a multiline chart for the patients is generated wherein x-axis is PMPM and two y-axes are admissions count and overall composite risk score.

Next, the PMPM at which the % of annual admissions exceeds a predetermined percentage (e.g., 10%) is identified, and this identified PMPM value is labeled as high risk PMPM. Thus, by way of example, 10 out of every 100 patients whose PMPM is more than the high risk PMPM had hospital admissions. Next, for this high risk PMPM value, the health risk score is determined and this health risk score is considered a high risk value.

The aforementioned process is repeated for PMPM at which the % of annual admissions exceed a predetermined percentage (e.g., 3%), and this PMPM value is labeled as moderate risk value. Then, for the moderate risk PMPM value, the health risk score is determined and the overall composite score is considered a moderate risk value.

According to various disclosed embodiments, the health risk scores are color-coded. If the health risk score is greater than the high risk value, the score is color coded red. If the health risk score is greater than moderate risk value but less than high risk value, the score is color coded yellow. It will be apparent that other color coding schemes may be used.

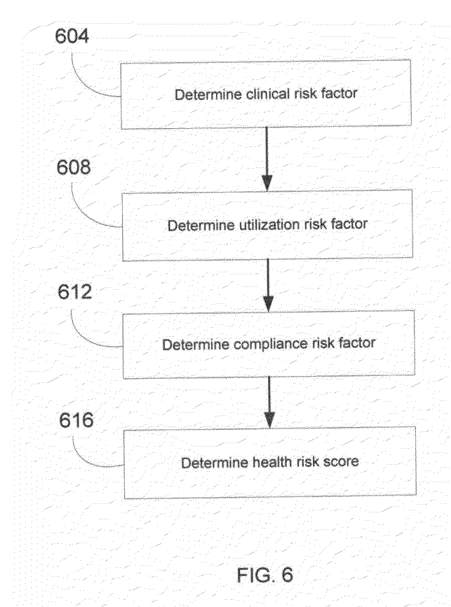

FIG. 6 is a flowchart of a process according to disclosed embodiments. Such a process can be performed, for example, by system 100, which may be implemented as an SOH analyzer, as described above, but the “system” in the process below can be any apparatus configured to perform a process as described. In block 604, system 100 determines a clinical risk factor. In block 608, system 100 determines a utilization risk factor. In block 612, system 100 determines a compliance risk factor. In block 616, system 100 determines a health risk score from the clinical risk factor, the compliance risk factor and the utilization risk factor.

According to some disclosed embodiments, a non-transitory computer-readable medium encoded with computer-executable instructions determines a plurality of patients' health risk score. The computer-executable instructions when executed cause at least one data processing system to: determine a clinical risk factor; determine a utilization risk factor; determine a compliance risk factor; and determine the health risk score from the clinical risk factor, the compliance risk factor and the utilization risk factor.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for population health risk stratification, the population comprising a plurality of patients, the method comprising:
determining clinical risk factors of the plurality of patients from the patients' clinical data;
determining utilization risk factors of the plurality of patients from per-member healthcare costs over a predetermined time period;
determining compliance risk factors of the plurality of patients, wherein the compliance risk factors are determined from appointment compliance factor, referral compliance factor and medication compliance factor;
determining health risk scores of the plurality of patients from the clinical risk factors, the utilization risk factors and the compliance risk factors; and
classifying population health risks using the health risk scores.

2. The method of claim 1, wherein the health risk score is represented by the following relationship: Health Risk Score=[X1*Clinical Risk Factor+X2*Utilization Risk Factor+X3*Compliance Risk Factor], wherein X1, X2 and X3 are coefficients.

3. The method of claim 1, wherein the per-member healthcare cost over a predetermined time period is per-member per-month (PMPM) cost.

4. The method of claim 3, wherein the utilization risk factor is represented by the following relationship: Utilization Risk Factor=[(Upper Limit−PMPM)/(Upper Limit−Lower Limit)]*100.

5. The method of claim 1, wherein the compliance risk factor is represented by the following relationship: Compliance Risk Factor=(Appointment Compliance Factor+Referral Compliance Factor+Medications Compliance Factor)/3.

6. The method of claim 1, wherein the referral compliance factor is determined from referral visits and number of referrals.

7. The method of claim 1, wherein the referral compliance factor is represented by the following relationship: Referral Compliance Factor=[(number of referral visits)/(number of referrals)]*100.

8. The method of claim 1, further comprising:
identifying disease models in clinical codes;
mapping disease codes to respective chronic diseases; and
determining, for the plurality of patients, health risk scores for the respective chronic diseases by applying disease models for the respective chronic diseases to the clinical data.

9. The method of claim 8, further comprising:
determining, for the plurality of patients, average health risk scores of the respective chronic diseases; and
determining, for the plurality of patients, weighted health risk scores of the respective chronic diseases, wherein the weighted health risk score is determined from the average health risk score of the chronic disease and the average cost of hospitalization due to the chronic diseases; and
storing weighted health risk scores in a memory.

10. The method of claim 8, wherein the disease code is based on International Classification of Diseases.

11. The method of claim 1, wherein the health risk scores indicate the risk of hospitalization.

12. A data processing system for population health risk stratification, the population comprising a plurality of patients, comprising:
at least one processor;
a memory connected to the processor, wherein the data processing system is configured to:
determine clinical risk factors of the plurality of patients from the patients' clinical data;
determine utilization risk factors of the plurality of patients from per-member healthcare costs over a predetermined time period;
determine compliance risk factors of the plurality of patients, wherein the compliance risk factors are determined from appointment compliance factor, referral compliance factor and medication compliance factor;
determine health risk scores of the plurality of patients from the clinical risk factors, the utilization risk factors and the compliance risk factors; and
classify population health risks using the health risk scores.

13. The data processing system of claim 12, wherein the health risk score is represented by the following relationship: Health Risk Score=[X1*Clinical Risk Factor+X2*Utilization Risk Factor+X3*Compliance Risk Factor], wherein X1, X2 and X3 are or coefficients.

14. The data processing system of claim 12, wherein the per-member healthcare cost over a predetermined time period is per-member per-month (PMPM) cost.

15. The data processing system of claim 12, wherein the utilization risk factor is represented by the following relationship: Utilization Risk Factor=[(Upper Limit−PMPM)/(Upper Limit−Lower Limit)]*100.

16. The data processing system of claim 12, wherein the compliance risk factor is represented by the following relationship: Compliance Risk Factor=(Appointment Compliance Factor+Referral Compliance Factor+Medications Compliance Factor)/3.

17. The data processing system of claim 12, wherein the referral compliance factor is determined from referral visits and number of referrals.

18. The data processing system of claim 12, wherein the referral compliance factor is represented by the following relationship: referral compliance score as [(number of referral visits)/(number of referrals)]*100.

19. The data processing system of claim 12, wherein the data processing system is configured to:
identify disease codes in clinical data;
map disease codes in the clinical data to respective chronic diseases; and
determine, for the plurality of patients, health risk scores for the respective chronic diseases by applying disease models for the respective chronic diseases to the clinical data.

20. The data processing system of claim 19, wherein the data processing system is configured to:
determine, for the plurality of patients, average health risk scores of the respective chronic diseases;
determine, for the plurality of patients, weighted health risk scores of the respective chronic diseases, wherein the weighted health risk score is determined from the average health risk score of the chronic disease and the average cost of hospitalization due to the chronic diseases; and
store weighted health risk scores in a memory.
